(19) United States
(12) Patent Application Publication
(10) Pub. No.: US 2010/0236637 A1
(43) Pub. Date: Sep. 23, 2010

(54) Surface Ventilator For A Compliant-Surface Flow-Control Device

(76) Inventor: James Edward Hendrix, JR., Oxford, MS (US)

Correspondence Address: Law Office of Michael D. Eisenberg;Intellectual Property Law, 3258 Caminito Eastbluff, Suite 89, San Diego, CA, 92037, US

(21) Appl. No.: 12/681,750

(22) PCT Filed: Mar. 3, 2008
(86) PCT No.: PCT/US08/55729

§ 371 Date: Apr. 5, 2010

Related U.S. Application Data
(60) Provisional application No. 60/978,096, filed on Oct. 5, 2007.

(51) Int. Cl. F15D 1/00

(52) U.S. Cl. 137/14; 137/803

(57) ABSTRACT

A compliant-surface flow-control device for reducing drag on objects moving through fluids is described. The device has a substrate having a plurality of ridges, a porous membrane covering the substrate, and interior spaces between the porous membrane and the substrate ridges.

### CROSS-REFERENCE TO RELATED APPLICATIONS

This application claims priority from U.S. Provisional Application Ser. No. 60/978,096 filed Oct. 5, 2007, which is hereby incorporated herein by reference in its entirety.

### TECHNICAL FIELD

The present invention relates to a compliant-surface flow-control device and some embodiments relate to a compliant-surface flow-control device having a porous membrane.

### BACKGROUND OF THE INVENTION

The subject invention generally relates to compliant-surface flow-control devices that control boundary flows. These devices function to reduce the drag on objects configured for travel through fluid media, such as airplanes and automobiles. Examples of such devices are shown in U.S. Pat. Nos. 3,161,285 and 5,961,080. These devices, also referred to as deturbulators, usually operate in conditions of time and spatially varying static pressures in the boundary flow. Without a means of equalizing the static pressure of the flow 3 with the fluid 4 inside the device 10 (see FIG. 1), the non-porous membrane 1 covering the device may be continually pressed down (see FIG. 2) by excessive pressure in the flow or it may be continually lifted up (see FIG. 3) by excessive pressure beneath the membrane. Both cases are detrimental to device performance. Prior approaches have employed discrete ventilation ports which comprise placing a hole (approximately 4 mm in diameter for example) at the each end of the deturbulator strips which are typically 9 to 18 inches long. However, the discrete ventilation ports may force fluid into the device (under the device membrane) or may pull fluid out of the device (out from under the membrane), thereby exacerbating the problem the vent ports are intended to solve. Furthermore, if the fluid is gaseous (e.g., air), condensation may accumulate between the device membrane 1 and substrate 2 (see FIG. 4), causing the non-porous membrane 1 to cling to the substrate 2, thereby immobilizing the membrane 1. When this occurs, the non-porous membrane 1 prevents evaporation by blocking the liquid from access to the flow outside the membrane. Only a minute area of the liquid around the edges may evaporate and eventually escape through the ventilation ports. Therefore, there is a need for a device that addresses this problem.

### BRIEF SUMMARY OF EMBODIMENTS OF THE INVENTION

According to one embodiment of the invention, a compliant-surface flow-control device comprises a rigid substrate having a plurality of parallel ridges that are uniformly or variably spaced apart; a porous membrane covering the substrate and touching the ridge tops; and interior spaces disposed between the porous membrane and the substrate ridges. The substrate is configured around the edges for attachment to a surface (membrane) in contact with a fluid.

In a further embodiment of the flow-control device, the porous membrane has a plurality of pores, and the pores are distributed in patterns over the membrane surface according to the static pressure variation in the flow stream over the device. Where the pressure of the fluid flow is greater, the membrane is not porous or not as porous and where the pressure of the fluid flow is less, the membrane is porous or more porous. The distribution of porosity may be used to create advantageous static pressure differences that yield improved dynamic motions in the membrane.

In yet another embodiment of the flow-control device, the concentration of the pores in the membrane is varied over different parts of the membrane.

In still a further embodiment of the flow-control device, the size and/or concentration of the membrane's pores varies in a manner to provide a lower size and/or concentration of pores in areas of the membrane where there is a greater static pressure in the boundary flow over the surface of the device, when the device is in operation.

In another embodiment of the flow-control device, the pores are configured to move a first static pressure inside the interior space toward equilibrium with a second static pressure outside the flow-control device when the pressure differences change at frequencies less than one (1) Hz and do not appreciably change pressure differences occurring faster than two (2) kHz.

In a further embodiment of the flow-control device, the ridges comprise raised supports and are substantially parallel and uniformly or variably spaced apart and the porous membrane is flexible and is from approximately 1 micron to 10 microns thick. The interior space is between approximately 10 microns to 50 microns thick and the flow-control device is between approximately 50 microns to 100 microns thick.

In another embodiment, the inside surfaces of the porous membrane and/or the substrate have hydrophobic properties.

In yet another embodiment, a method of ventilating a compliant-surface flow-control device on a body moving through a fluid medium, comprises distributing a concentration of ventilation pores over the area of the compliant-surface.

In a variant of the method of ventilating a compliant-surface flow-control device, the method may further comprise determining the usual static pressure distribution over the surface flow-control device when the device is operated in a fluid medium and varying the size and/or distribution of the ventilation pores in accordance with a determined static pressure distribution.

In another variant of the method of ventilating a compliant-surface flow-control device, the method may further comprise placing a lower concentration of pores at locations on the compliant-surface flow-control device where the static pressure is greater, when the device is operated in a fluid medium.

In a further variant of the method of ventilating a compliant-surface flow-control device, the method may comprise placing smaller sized pores at locations on the compliant-surface flow-control device where the static pressure is greater, when the device is operated in a fluid medium.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is a sectional view of a typical compliant-surface flow-control device;

FIG. 2 is sectional view of a compliant-surface flow-control device under excessive flow pressure, outside the device;

FIG. 3 is a sectional view of a compliant-surface flow-control device with excessive pressure inside the device;

FIG. 4 is a sectional view of a compliant-surface flow-control device having condensation inside the device;

FIG. 5 is a sectional view of a compliant-surface flow-control device in accordance with the principles of the invention, taken along the line 5′-5′ in FIG. 7;

FIG. 6 is a sectional view of a compliant-surface flow-control device in accordance with the principles of the invention, taken along the line 6′-6′ in FIG. 7;

FIG. 7 is a perspective view of a compliant-surface flow-control device in accordance with the principles of the invention, having a membrane containing a concentration of pores that varies with position on the membrane;

FIG. 8 is a perspective view of a compliant-surface flow-control device on an aircraft; and

FIG. 9 is a flow chart describing a method of ventilating a compliant-surface flow-control device.

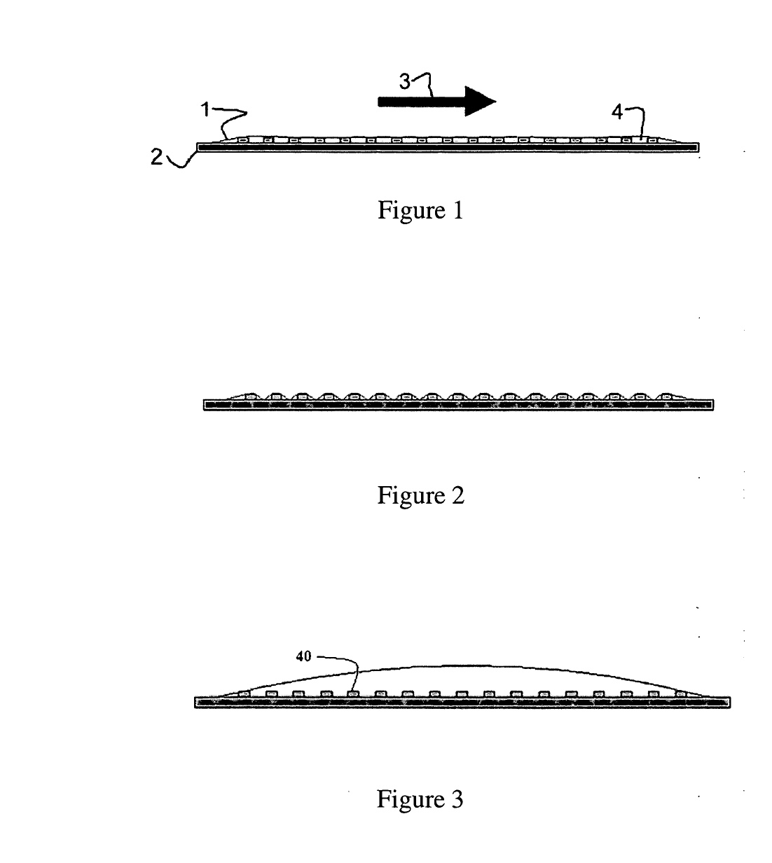

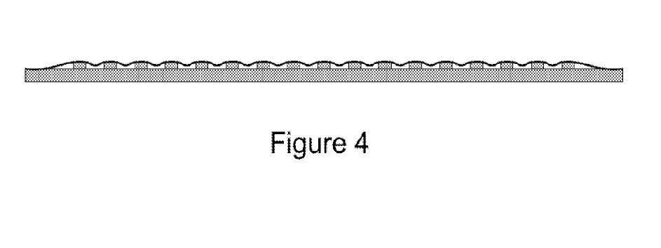

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

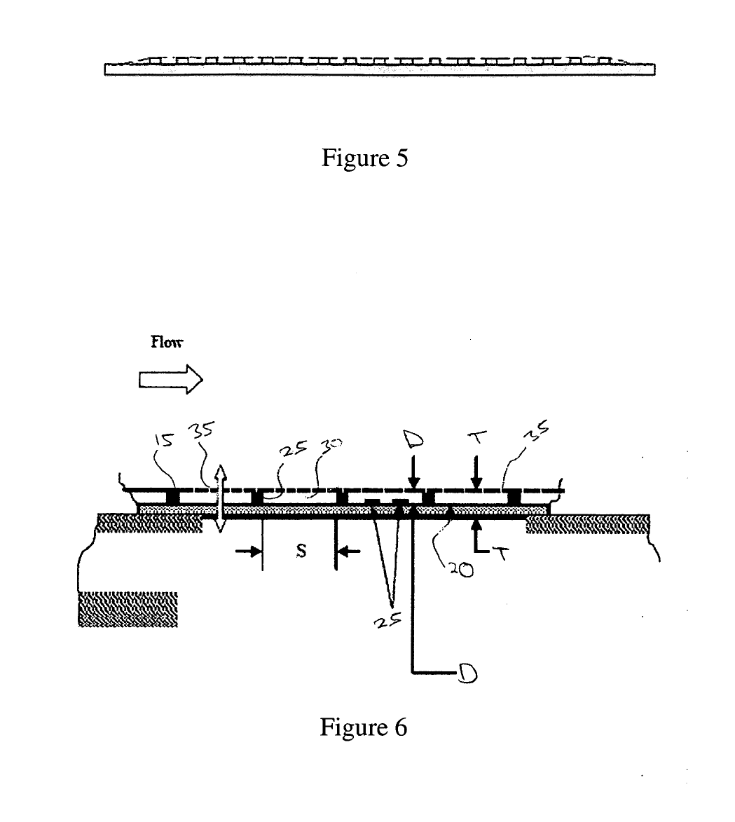

The present invention addresses some of the problems of the prior art by providing a surface ventilation apparatus and method. The present invention is directed toward a compliant-surface flow-control device 10. According to one embodiment, referring to FIG. 5, a compliant-surface flow-control device 10 in accordance with the principles of the present invention includes a slightly porous membrane 15. The membrane porosity allows fluid inside the device to exchange with the flow outside the device 10, at relatively slow rates, while remaining opaque in the frequency band at which the device operates. At very low frequencies (less than 1 Hz), the porous membrane leaks enough pressure to equalize the static pressure differences between it and the outside and also to exchange humidity. At high frequencies (greater than 2 kHz) the porous membrane 15 will restrict flow through the membrane 15 and thereby may assume the dynamic properties necessary for flow-control operation. For example, in one embodiment the pores are configured to prevent a first static pressure inside the interior space from reaching equilibrium with a second static pressure outside the flow-control device when the pressure differences change at frequencies faster than about two 2 kHz. A practical maximum pressure equalization rate that should be sustainable in air by the porous surface corresponds to an altitude change of rate of 500 feet per minute at sea level in the ICAO Standard Atmosphere. This equals a static pressure change rate of 0.3 mb per second. This rate of change in the static pressure of the fluid flow over the device should be tracked by the static pressure of the fluid inside the device to within 0.5 mb (a pressure difference corresponding to 15 feet of altitude change) of the pressure of the fluid flow over the device.

Referring to FIGS. 5-8, According to one embodiment, the device 10 comprises a rigid substrate 20 having a plurality of parallel ridges 25 that uniformly or variably spaced apart. A porous membrane 15 covers to the substrate 20 and touches the ridge tops and interior spaces 30 are disposed between the porous membrane 15 and the substrate 20 ridges 25.

The porous membrane 15 is flexible and typically may be from 1 micron to 10 microns thick. The substrate ridge 25 heights typically may be between 10 microns to 50 microns and may vary from ridge to ridge. The flow-control device 10 typically may be between 50 microns to 100 microns thick. When pressure differences above and below the membrane change at frequencies of one (1) Hz or less, fluid must be able to move through the pores freely enough to prevent the membrane from either lifting away from the ridges, because of excess pressure inside the device, or pressing down into the ridge spaces, because of excess pressure outside the device. However, when pressure differences above and below the membrane change at frequencies of two (2) kHz or more, the porosity level must not be so high that appreciable leakage of fluid through the membrane could occur and thereby diminish membrane motion caused by the rapid pressure difference changes.

If the fluid is gaseous, then moisture will transport through the pores to equalize the humidity levels inside the device and outside. This allows the void spaces between the membrane and the substrate ridges to be expel condensed moisture when the device is exposed to fluid flow with relative humidity levels less than 100%. Surface tension in condensation in the void spaces diminishes performance by restricting movement of the membrane.

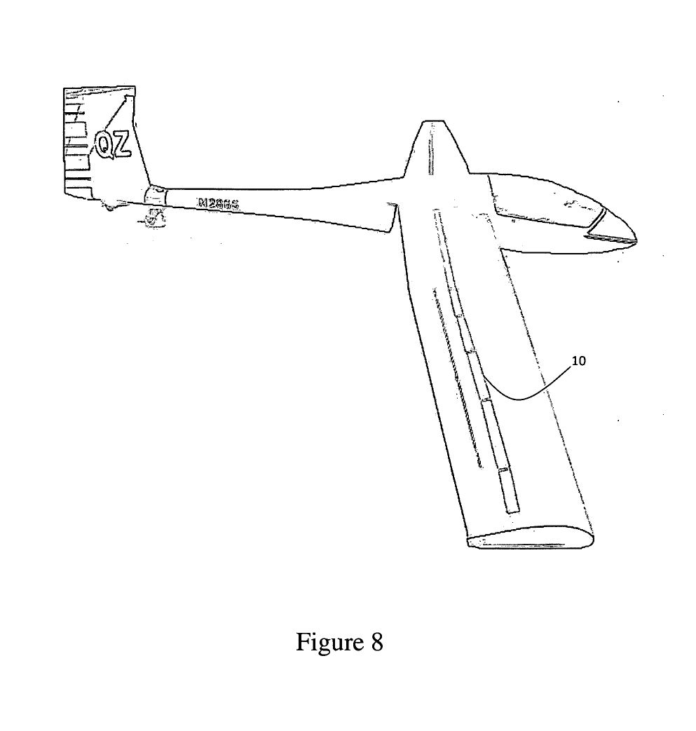

FIG. 8 illustrates one example environment, on the wing of an aircraft, in which the device 10 may operate. Some other applications for the compliant-surface flow-control device include placing the device on the surfaces of automobiles and trucks.

In another embodiment of the flow-control device, the ridges 25 may be uniformly or variably spaced apart distances S of approximately 0.5 to 1.0 millimeters. The porous membrane 15 is flexible and may be from approximately 1 micron to 10 microns thick. The substrate ridge heights may be between approximately 10 microns to 50 microns thick D. The flow-control device 10 may be between approximately 50 microns to 100 microns thick T. The substrate may be configured for attachment to a surface in contact with a fluid. In one embodiment, the membrane 15 may be composed of Mylar and the substrate 20 composed of aluminum tape. The ridges 25 may be formed by passing the aluminum tape through steel rollers. Alternatively, the substrate 20 may be formed from extruded plastic or may be integrated directly in the surface exposed to fluid flow; for example, molded directly into the surface of an aircraft wing or vehicle surface.

In a further embodiment of the flow-control device, the porous membrane has a plurality of pores 35. The pore 35 size and pore concentration (i.e. pores per unit area) are configured to permit a first pressure inside the interior space to move toward equilibrium with a second pressure outside the flow-control device, when the flow-control device is operated in conjunction with an object moving through a fluid.

The porosity of the membrane may be an intrinsic feature of the material comprising the membrane 15 (such as an open-wall foam structure) or the pores may be added by laser punching hole-patterns in the membrane 15 before assembling the device 10. The degree of porosity should be the least amount that will allow the device to equalize pressure differences between the external flow and the internal fluid at frequencies up to one (1) Hz and equalize humidity levels when a boundary flow is at less than 100% relative humidity within several minutes at operating temperatures above the freezing point for water under the flight conditions. This will have acceptable effect on performance of a flow-control device that operates at frequencies over two (2) kHz. Also, it will minimize flow inside the device (under the membrane) due to a pressure gradients in the boundary flow. If the flow inside the device is large enough, it could interfere with performance by lifting the membrane 15 away from contact with the substrate ridges 25.

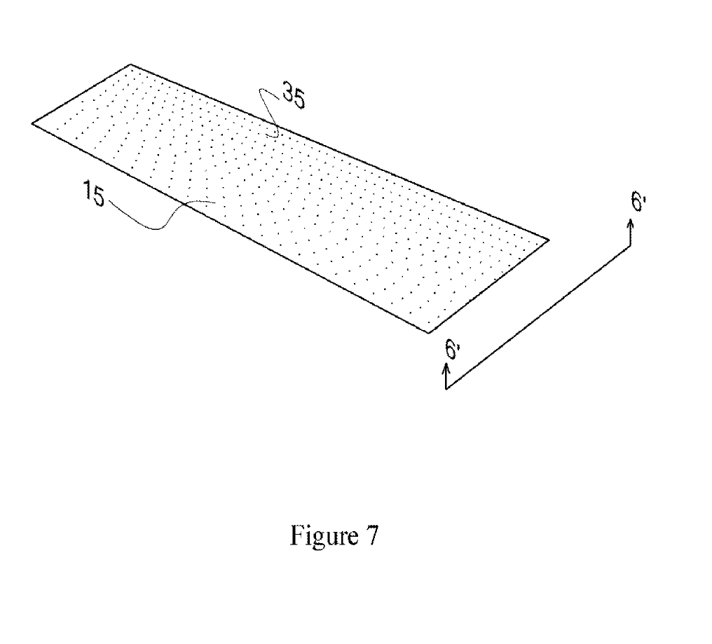

In another embodiment of the flow-control device, the concentration and/or size of the pores are distributed in patterns over the membrane surface according to the static pressure variation in the flow stream over the device 10. FIG. 7 illustrates a representation of one example of how the concentration of pores may vary on the membrane. The pore size as represented in the figure is exaggerated for purposes of illustration. Where the pressure of the boundary flow is greater relative to other parts of the device, the membrane is not porous or less porous and where the pressure of the fluid flow is less, the membrane is porous or more porous. The distribution of porosity may be used to create advantageous static pressure differences that yield improved dynamic motions in the membrane.

In a further embodiment of the flow-control device, the inside surfaces of the porous membrane and/or the substrate exhibit a hydrophobic property. The surfaces either are coated with a hydrophobic coating or are constructed from materials having a hydrophobic property. This feature serves to deter clinging of the membrane to the substrate when condensed moisture is present between the membrane and the substrate.

In yet another embodiment, a method of ventilating a compliant-surface flow-control device on a body moving through a fluid medium, comprises distributing a concentration of ventilation pores over the area of the compliant-surface.

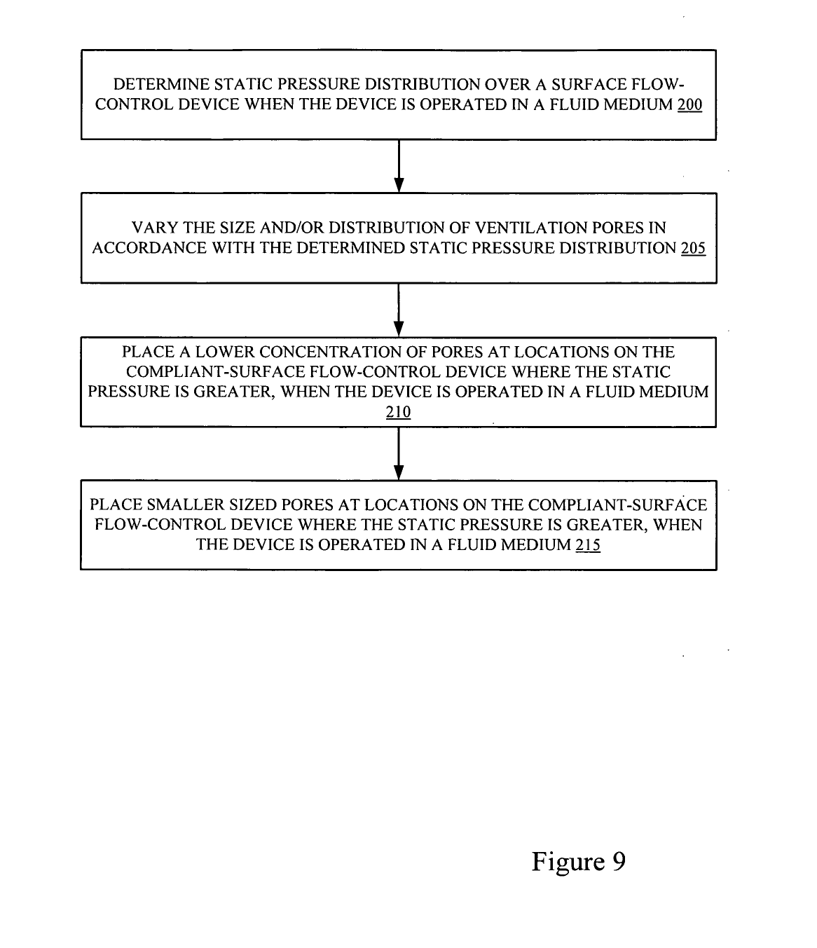

In a variant of the method of ventilating a compliant-surface flow-control device, referring to FIG. 9, the method may further comprise determining in a step 200 the usual static pressure distribution over the surface flow-control device when the device is operated in a fluid medium and in a step 205 varying the size and/or distribution of the ventilation pores in accordance with a determined static pressure distribution.

In another variant of the method of ventilating a compliant-surface flow-control device, the method may further comprise in a step 210 placing a lower concentration of pores at locations on the compliant-surface flow-control device where the static pressure is greater, when the device is operated in a fluid medium.

In a further variant of the method of ventilating a compliant-surface flow-control device, the method may comprise in a step 215 placing smaller sized pores at locations on the compliant-surface flow-control device where the static pressure is greater, when the device is operated in a fluid medium.

While various embodiments of the present invention have been described above, it should be understood that they have been presented by way of example only, and not of limitation. Likewise, the various diagrams may depict example architectures or other configurations for the invention that aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical configurations can be implemented to implement the desired features of the present invention. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

All patents and publications referenced or mentioned herein are indicative of the levels of skill of those skilled in the art to which the invention pertains, and each such referenced patent or publication is hereby incorporated by reference to the same extent as if it had been incorporated by reference in its entirety individually or set forth herein in its entirety. Applicants reserve the right to incorporate physically into this specification any and all materials and information from any such cited patents or publications.

The specific methods and apparatuses described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention.

The invention described illustratively herein suitably may be practiced in the absence of any element or elements, or limitation or limitations, which is not specifically disclosed herein as essential. Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A compliant-surface flow-control device, comprising:
a substrate having a plurality of ridges;
a porous membrane covering the substrate; and
interior spaces between the porous membrane and the substrate ridges.

2. The flow-control device of claim 1, wherein the substrate is configured for attachment to the membrane in contact with a fluid.

3. The flow-control device of claim 1, wherein the concentration of the pores in the membrane is varied over different parts of the membrane.

4. The flow-control device of claim 4, wherein the size and/or concentration of the membrane's pores varies in a manner to provide a lower size and/or concentration of pores in areas of the membrane where there is a greater static pressure in the boundary flow over the surface of the device, when the device is in operation.

5. The flow-control device of claim 4, wherein the pores are configured to move a first static pressure inside the interior space toward equilibrium with a second static pressure outside the flow-control device when the pressure differences change at frequencies less than one 1 Hz.

6. The flow-control device of claim 5, wherein the pores are configured to prevent the first static pressure inside the interior space from reaching equilibrium with a second static pressure outside the flow-control device when the pressure differences change at frequencies faster than two 2 kHz.

7. The flow-control device of claim 1, wherein:
the ridges comprise raised supports and are substantially parallel and uniformly or variably spaced apart;
the porous membrane is flexible and is from approximately 1 micron to 10 microns thick;
the interior space is between approximately 10 microns to 50 microns thick; and
the flow-control device is between approximately 50 microns to 100 microns thick.

8. The flow-control device of claim 1, wherein the inside surfaces of the porous membrane has a hydrophobic property.

9. The flow-control device of claim 8, wherein the surface of the substrate is hydrophobic.

10. A method of ventilating a compliant-surface flow-control device on a body moving through a fluid medium, comprising distributing a concentration of ventilation pores over an area of the compliant-surface.

11. The method of claim 10, further comprising determining the usual static pressure distribution over the surface flow-control device when the device is operated in a fluid medium and varying the size and/or distribution of the ventilation pores in accordance with a determined static pressure distribution.

12. The method of claim 11, further comprising placing a lower concentration of pores at locations on the compliant-surface flow-control device where the static pressure is greater when the device is operated in a fluid medium.

13. The method of claim 11, further comprising placing smaller sized pores at locations on the compliant-surface flow-control device where the static pressure is greater when the device is operated in a fluid medium.
